(19) United States
(12) Patent Application Publication
(10) Pub. No.: US 2011/0147123 A1
(43) Pub. Date: Jun. 23, 2011

(54) TOP TREAD FOR ALUMINUM LADDER

(75) Inventor: Luhao Leng, Xiamen (CN)

(73) Assignee: NEW-TEC INTEGRATION(XIAMEN) CO.,LTC.

(21) Appl. No.: 13/059,301

(22) PCT Filed: Sep. 2, 2009
(86) PCT No.: PCT/CN09/73689

§ 371 Date: Feb. 16, 2011

(30) Foreign Application Priority Data
Sep. 27, 2008 (CN) 200810071881.0

(51) Int. Cl. E06C 7/00; E06C 7/50

(52) U.S. Cl. 182/194

(57) ABSTRACT

A top tread for aluminum ladder includes a splice aluminum member 1 assembled by two or more aluminum single elements and two side plastic members 3 and a metal tube assembly 2. The front and the rear end of the splice aluminum member 1 are equipped with side skirts 111, 131 which are set downwardly. The upper and the lower end of the side plastic members 3 are equipped with an upper and a lower covering edge 31, 32 by which the two side plastic member 3 can clamp the two sides of the splice aluminum member 1 or the two sides of an assembly unit formed by the metal tube 2 and the splice aluminum member 1, and the upper and the lower covering edges 31, 32 can clamp the two side interspaces between the front and the back side skirt 111, 131 at the same time.

### FIELD OF THE INVENTION

The invention relates to a ladder, especially to top tread for simple aluminum ladder.

### BACKGROUND OF THE INVENTION

The simple aluminum ladder is made of aluminum material; consist of two front leg tubes made of aluminum material, two back leg tubes made of aluminum material, one or more bottom tread and a top tread made of aluminum material. The two front leg tubes and the two corresponding back leg tubes pivot joint together, so that the front leg tubes and the back leg tubes can open up to be herringbone supporting structure. The one or more bottom tread is connected between the two front leg tubes. The number of the bottom tread relies on the height of the ladder. The higher the ladder is, the more the bottom tread is. For a simple ladder, it has one or two bottom treads, but not limited to more. The top tread is connected between the two front leg tubes and the two back leg tubes. The front sides of the top tread pivot joint separately with the two front leg tubes, and the back sides of the top tread pivot joint separately with the back leg tubes by connecting board. When the front leg tubes and the back leg tubes are opening out, the top tread maintains between the front leg tubes and the back leg tubes, so the ladder opens up. When the front leg tubes and the back leg tubes are enfolded, the top tread is collected at the space between the front leg tubes and the back leg tubes, so that the ladder is enfolded. The top tread is used for stand when the ladder is in use, so the size is bigger than the bottom tread. If the top tread is made up of full aluminum material, the manufactory is difficult, and it needs more materials and costs more, reducing the competition of the products.

### SUMMARY OF THE INVENTION

The object of the present invention is to achieve the disadvantages of the existing technology; it provides a top tread for simple aluminum ladder, which applies aluminum-plastic composite manufactory, has advantages of easily manufactory, graceful outline, stable supporting and low production cost, promoting the competition of the product in the market.

The technology of the present invention to resolve the problem of the existing technology is:

A top tread for simple aluminum ladder, includes:
A splice aluminum member assembled by two or more aluminum single elements, the front and the rear end of the splice aluminum member are equipped with side skirts which are set downwardly;
Two side plastic members, the upper and the lower end of the side plastic members are equipped with an upper and a lower covering edge by which the two side plastic members can clamp the two sides of the splice aluminum member, and the upper and the lower covering edges can clamp the two side interspaces between the front and the back side skirt, which forms the integral top tread.

The invention further includes metal tube to enhance the intensity of the top tread, at least two tubes of the metal tube are placed separately on the two sides of the splice aluminum member, two side plastic members can clamp the two sides of an assembly unit formed by the metal tube and the splice aluminum member, and the upper and the lower covering edges can clamp the two side interspaces between the front and the back side skirt.

The metal tube is two single tubes, or structure of H-shape or U-shape or frame shape made by a tube.

The metal tube is tube of iron material or of aluminum material.

The upper end of the aluminum single element is equipped with several transverse raised lines by extrusion forming, and the upper covering edge of the side plastic member is equipped with breach making room for the raised lines of the single element.

The upper surface of the single element is equipped with several printing structures in particular rows by extrusion forming.

The end of the splice aluminum member and the tube of the metal tube are fixed by core rivet. And the inner of the upper covering edge of the side plastic member is equipped with concave groove making room for the rivet.

The aluminum single element is single-layer structure or a double-layer structure of single or multiple cavities.

The link edge of two neighboring aluminum single elements is equipped with side U-shape end which is set opening inward, the side U-shape ends hook holding the two neighboring aluminum single elements together.

The link edge of the first single element of the two neighboring aluminum single elements is equipped with upright hook, and the link edge of the second single element is equipped with U-shape end which is set opening u) upwards, the upright hook of the first single element inserts to the U-shape opening of the second single elements holding the first and the second single elements together.

The link edge of the first single element of the two neighboring aluminum single elements is equipped with U-shape end opening upwards and crosswise hook extending outwards, and the link edge of the second single element is equipped with side U-shape end opening inward and upright hook extending downwards, the crosswise hook of the first single element works cooperate with the U-shape opening of the side U-shape end of the second single element, the upright hook of the second single element works cooperate with the U-shape opening of the U-shape end of the first single element holding the first and the second single element together.

The beneficial effects of the invention are: as with the splice aluminum member, the side plastic member and the metal tube to composite the top tread, the splice aluminum member is met together by two or more single elements, the width of the single elements is small, so that it can apply light aluminum extrusion presser, the splice aluminum member is equipped with metal tube, the intensity of the top tread enhances, making the supporting more stable. The metal tube has the effect of connecting the single element. The two sides of the splice aluminum member or the two sides of the assembly unit formed by the splice aluminum member and the metal tube has the side plastic member to ferrule connect, it can clamp the two side interspaces between the front and the back side skirt, making the top tread graceful outlines, saving the use of the aluminum material, reducing the product cost. The printing on the surface of the single elements makes the top tread more graceful. The upper surface of the single element is equipped with raised lines, making the upper surface being stereoscopic effect and convenient for hook with the splice aluminum member, antiskid in use at the same time. The link edge of the two neighboring single elements applies two side U-shape end or a upright hook structure, a U-shape end structure or a crosswise hook with U-shape end, and a upright hook with U-shape end structure to connect the two single elements, making the connect stable and easy to manufactory.

For detail description of the present invention with the drawings and the embodiments, but not limited to the embodiments.

### BRIEF DESCRIPTION OF THE DRAWINGS

FIG. 1 illustrates the structure of the ladder of the present invention;

FIG. 2 illustrates the structure of the embodiment 1;

FIG. 3 illustrates the top view of the embodiment 1;

FIG. 4 illustrates the section view of the A-A line in the FIG. 3;

FIG. 5 illustrates the section view of the B-B line in the FIG. 3;

FIG. 6 illustrates the enlarge view of the C section in the FIG. 4;

FIG. 7 illustrates the enlarge view of the D section in the FIG. 5;

FIG. 8 illustrates the decomposition view of the embodiment 1;

FIG. 9 illustrates the structure of the side plastic member (reverse station);

FIG. 10 illustrates the structure of the splice aluminum member of the embodiment 1;

FIG. 11 illustrates the sectional view of the splice aluminum member of the embodiment 1;

FIG. 12 illustrates the decomposition view of the embodiment 2;

FIG. 13 illustrates the sectional view of the splice aluminum member of the embodiment 3;

FIG. 14 illustrates the enlarge view of the E section of the FIG. 13;

FIG. 15 illustrates the sectional view of the splice aluminum member of the embodiment 4;

FIG. 16 illustrates the enlarge view of the F section of the FIG. 15;

FIG. 17 illustrates the structure of the splice aluminum member of the embodiment 5;

FIG. 18 illustrates the sectional view of the splice aluminum member of the embodiment 5;

FIG. 19 illustrates the enlarge view of the G section of the FIG. 18;

FIG. 20 illustrates the sectional view of the splice aluminum member of the embodiment 6;

FIG. 21 illustrates the enlarge view of the H section of the FIG. 20.

### DETAILED DESCRIPTION OF THE INVENTION

### Embodiment 1

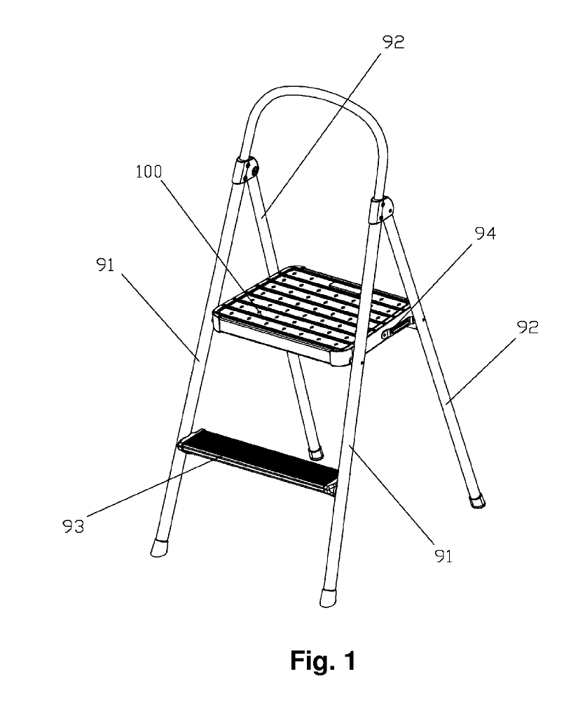

refer to the FIG. 1, the present invention provides a top tread structure for simple aluminum ladder, the ladder includes two front leg tubes 91 made of aluminum material, two back leg tubes 92 made of aluminum material, a bottom tread 93 made of aluminum material, and a top tread 100. The two front leg tubes 91 is made from a straight tube bent to U-shape, the top of which can be formed handrail. Two front leg tubes 91 and the corresponding back leg tubes 92 pivot joint at the top, so that the front leg tube 91 and the back leg tube 92 can open up to be herringbone supporting structure. The bottom tread 93 connects between the two front leg tubes 91, there could be more than one bottom tread when depends, the top tread structure 100 is connecting between the two front leg tubes 91 and the two back leg tubes 92, the front side of the top tread 100 pivot joint separately to the two front leg tubes 91, and the back side of the top tread 100 is pivot joint separately to the two back leg tubes 92 by the connecting board 94. When the front leg tubes 91 and the back leg tubes 92 are opening up, the top tread structure 100 maintains between the front and the back leg tubes, making the ladder open out. When the front leg tubes 91 and the back leg tubes 92 enfold, the top tread structure 100 collects at the interspaces between the front and the back leg tubes, making the ladder enfolds. The ladder could be used for seat; here the top tread structure 100 is equal to a seat.

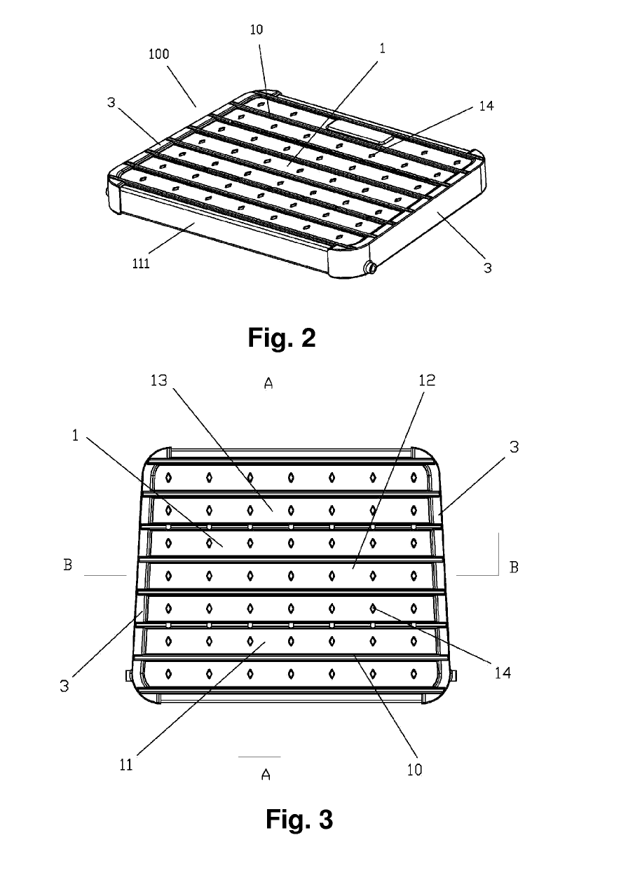

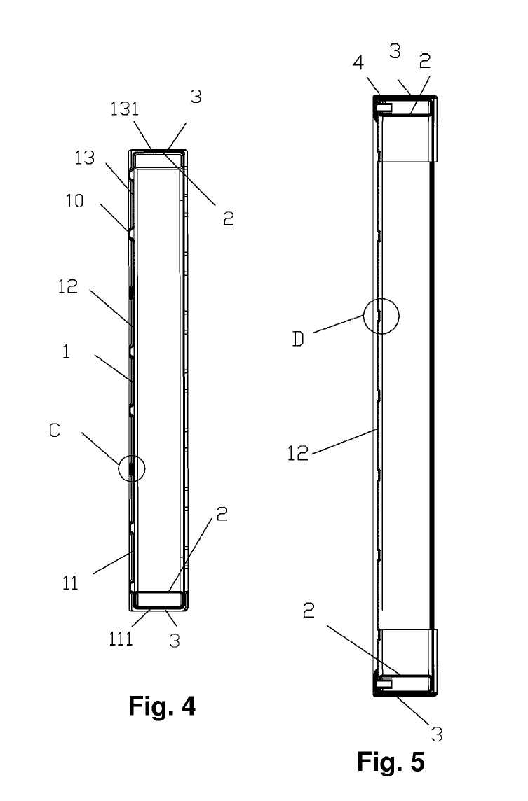

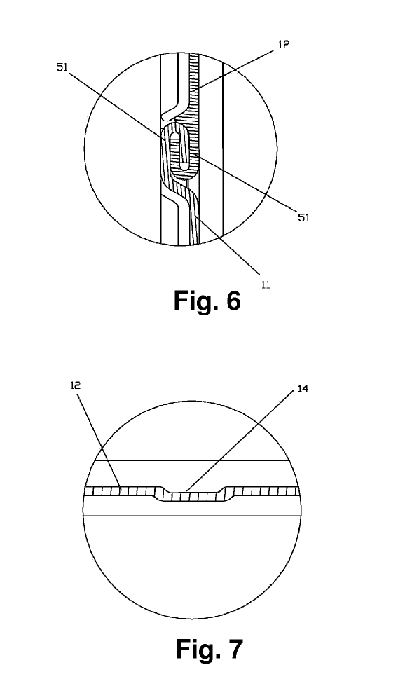

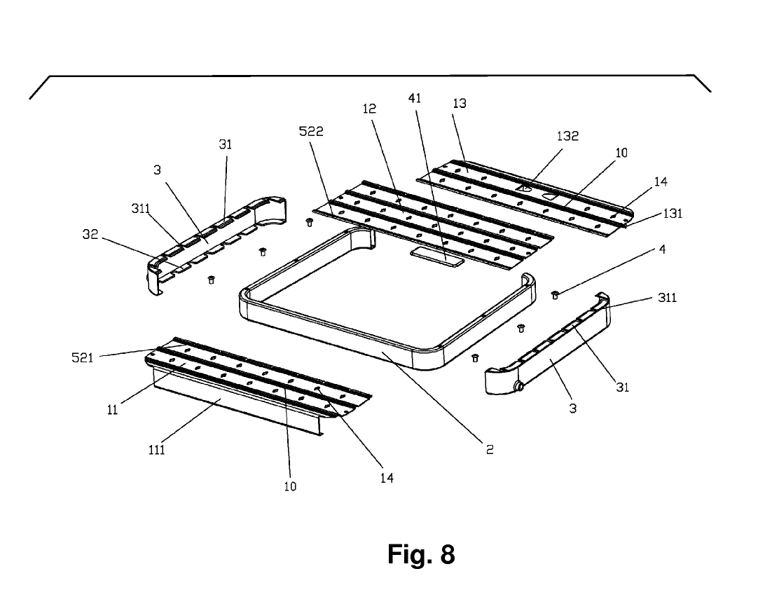

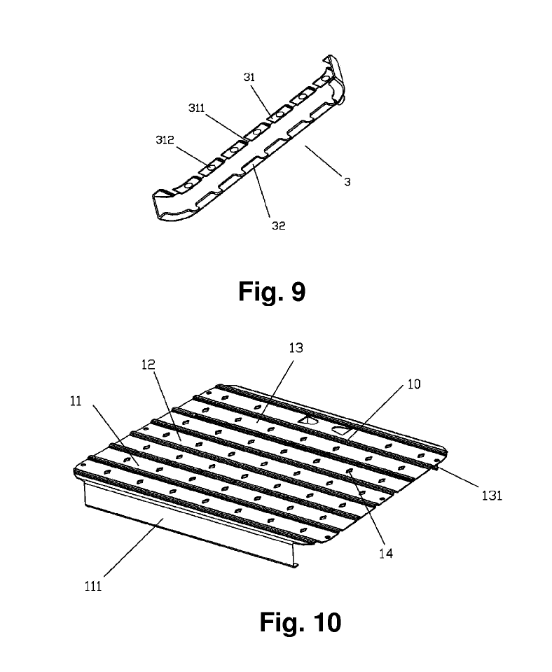

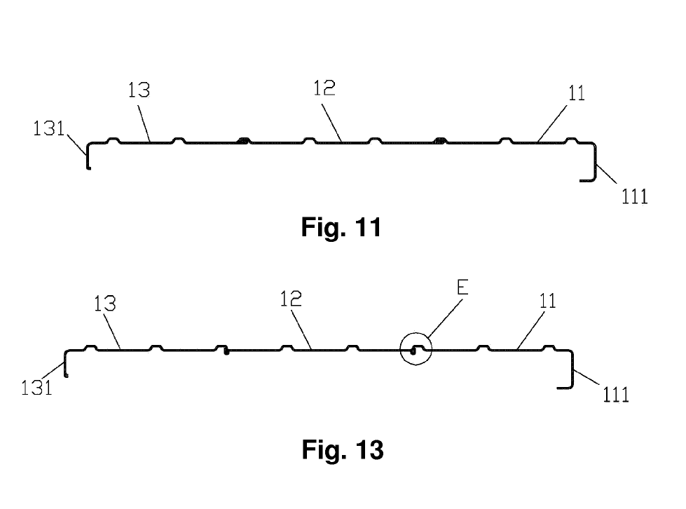

Refer to the FIG. 2 to FIG. 11, the top tread structure 100 includes:

A splice aluminum member 1 assembled by three aluminum single elements: the front aluminum single element 11, the middle aluminum single element 12, and the back aluminum single element 13 which are splice one by one, the front and the back end of the splice aluminum member 1 are equipped with side skirts which are set downwardly, the front side skirt 111 is set in the front of the front aluminum single element 11, the back side skirt 131 is set at the back of the back aluminum single element 13;
A metal tube 2, which is made from a straight tube bent to U-shape by tube bending machine. The metal tube 2 is placed on the front side end and the bottom of the two side end of the splice aluminum memberl, and the metal tube 2 is placed inside of the front side skirt 111 of the splice aluminum member. The metal tube 2 is fixed to the two side ends of the splice aluminum member 1;
Two side plastic members 3, which can clamp the two side of the assembly of the metal tube 2 and the splice aluminum member 1, and the two side plastic member 3 can clamp the two side interspaces between the front side skirt 111 and the back side skirt 131 of the splice aluminum member.

Thereof:

The metal tube 2 is tube of iron material or aluminum material;
The top end of the every aluminum elements, which are the front aluminum element 11, the middle aluminum element 12 and the back aluminum element 13, is equipped with some raised lines 10, which is made by extrusion.

The upper surface of every single element, which is the front single element 11, the middle single element 12, and the back single element 13, is equipped with printing structure 14 in particular rows by extrusion forming. The printing structure 14 is rhombus shape which is set concave down compare to the upper surface of every single element, the front single element 11, the middle single element 12, and the back single element 13.

The upper and the lower end of the plastic members 3 are equipped with an upper covering edge 31 and a lower covering edge 32, and the upper covering edge 31 is equipped with breach 311 for making room for the raised lines 10 of the single element.

The end of the splice aluminum member 1 and the metal tube 2 is fixed by core rivet 4, and the inner of the upper covering edge of the side plastic member 3 is equipped with several concave grooves 312 making room for the rivet 4.

The aluminum single element, which is the front single element 11, the middle single element 12, and the back single element 13, is single-layer structure.

The link edges of the splice neighboring two single elements are equipped with side U-shape end opening inward, the back edge of the front single element 11 splice connect with the front edge of the middle single element 12. the link edge of the front single element 11 and the middle single element 12 is equipped with side U-shape end 51, that is the side U-shape end 51 in the back side edge of the front single element 11, the side U-shape end 51 in the front side edge of the middle single element 12. The side U-shape end 51 in the back side of the front single element 11 hooks with the side U-shape end 51 in the front side of the middle single element 12 holding the front single element 11 and the middle single element 12 together. As the same, the back edge of the middle single element 12 splice together with the front edge of the single element 13, the back edge of the single element 12 and the front edge of the single element 13 are equipped with side U-shape end to hook together holding the middle single element 12 and the back single element 13 together. The front single element 11, the middle single element 12, and the back single element 13 splice together to form the splice aluminum member 1.

The link edge of the two neighboring single elements is equipped with several bayonets working corporately. The back side edge of the front single element 11 is equipped with bayonet 521, the front side edge of the middle single element 12 is equipped with bayonet 522, as the back side edge of the front single element 11 work corporate with the front side edge of the middle single element 12, the bayonet 521 of the front single element 11 work corresponding with the bayonet 522 of the middle single element 12; there are bayonets in the back side edge of the middle single element 12 and the front side edge of the back single element 13; a plastic covering 41 is provided to cover the hole 132 of the back single element 13.

The top tread for simple aluminum ladder of the present invention is assembled by the splice aluminum member 1, side plastic member 3 and the metal tube 2. The splice aluminum member 1 is formed by the splice of the front single element 11, the middle single element 12 and the back single element 13. The small width of every single element makes the extrusion on the light aluminum extrusion presser. The corner of every single element, as the same of the corner of the splice aluminum member, could be made to a fillet by cold pressing. The metal tube 2 is made from tubes of iron material or aluminum material. The metal tube could be U-shape made from a straight tube bent by tube bender. Or the metal tube could be H-shape or frame shape or a double-single-tube. These shapes of metal tube have the same feature of at least two tubes placed separately in the two sides of the splice aluminum member 1. When the metal tube 2 is U-shape, the three sides corresponds to the front and the two sides of the splice aluminum member 1; the two side tubes of the metal tube 2 are fixed with the two sides end of the splice aluminum member 1, forming the assembly unit of the metal tube 2 and the splice aluminum member 1. The splice aluminum member 1 and the metal tube 2 are fixed together by rivet 4 or other cold pressing. The side plastic member 3 is formed by molding, playing the effect of covering the edge. The side plastic member 3 is equipped with an upper covering edge 31 and a lower covering edge 32, so that the side plastic member 3 is formed with notch. The notch can clamp the two sides of the assembly unit formed by the metal tube 2 and the splice aluminum member 1 and the two side interspaces between the front side skirt 111 and the back side skirt 131 at the same time. It makes the top tread 100 more graceful, and reduce the use of the aluminum material, and the cost of the product. The surface of the single elements are equipped with printing structure 14 by extrusion pressing on particular rows, the printing could be geometric figures such as rhombic, or triangle or circle, even other structure like flowers. The printing makes the top tread more beautiful and antiskid. The printing should be linearly arranged, or curve arranged or other. The upper end of the single element is equipped with crosswise raised lines by extrusion forming. And these raised lines have the effects of beauty, antiskid and easy for the clamp of the side plastic member 3.

In the manufactory, firstly, making the three single elements, that is the first single element 11, the middle single element 12 and the back single element 13, and the raised lines 10, the printing 14, the link edges and the side skits. Bending a metal tube to be the metal tube 2 of U-shape; splice the three single element together to form the splice aluminum member 1; assembling the splice aluminum member 1 and the metal tube 2, and fixing the two ends of the splice aluminum member 1 with the corresponding two side tubes of the metal tube 2 to be the assembly unit; clamp the two side interspaces between the front side skirt 111 and the back side skirt 131 by the side plastic member 3 to form the top tread 100.

### Embodiment 2

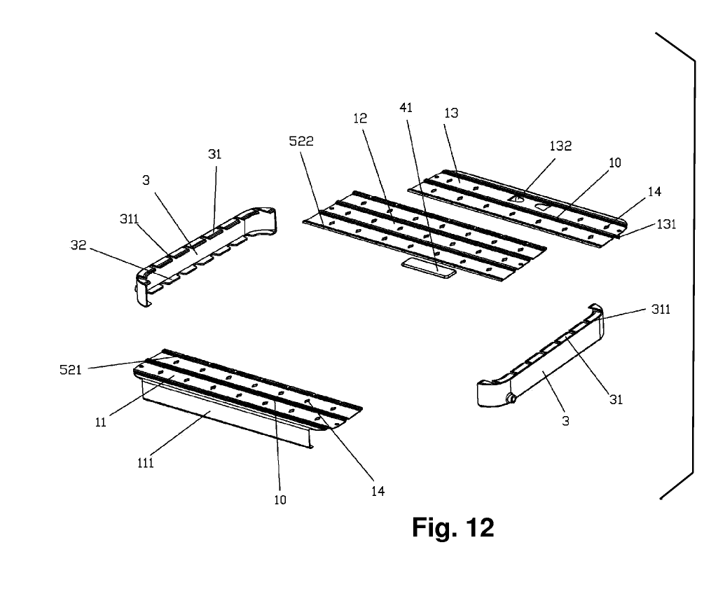

refer to the FIG. 12, the top tread for simple aluminum ladder in the present invention has differences from the embodiment 1. the embodiment 2 has not metal tube, and the top tread is composite by the splice aluminum member 1 and the side plastic member 3. Without metal tube, it needs not rivet to fix the splice aluminum member and the metal tube.

### Embodiment 3

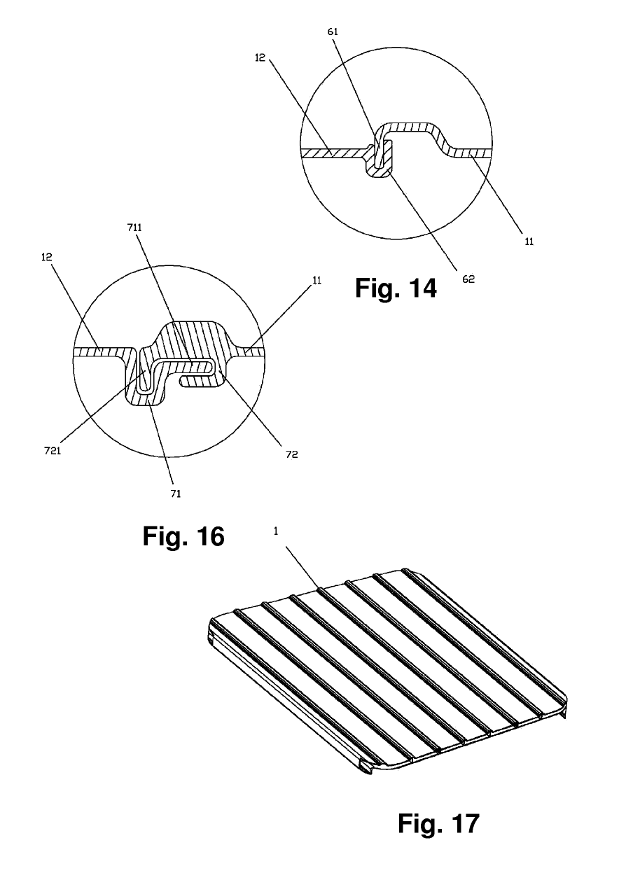

refer to the FIG. 13 and the FIG. 14, the top tread for simple aluminum ladder in the present invention has differences from the embodiment 1. In the embodiment 3, the link edge of the first single element of the two splice neighboring single elements (that is the front single element 11) is equipped with upright hook 61, and the link edge of the second single element of the two splice neighboring single elements (that is the middle single element 12) is equipped with U-shape end 62 which is opening upwards. The upright hook 61 of the first single element (that is the front single element 11) inserts to the U-shape end 62 of the second single element (that is the middle single element 12) holding the neighboring front single element 11 and the middle single element 12 together.

The splice of the middle single element 12 and the back single element 13 applies the same structure to splice together.

### Embodiment 4

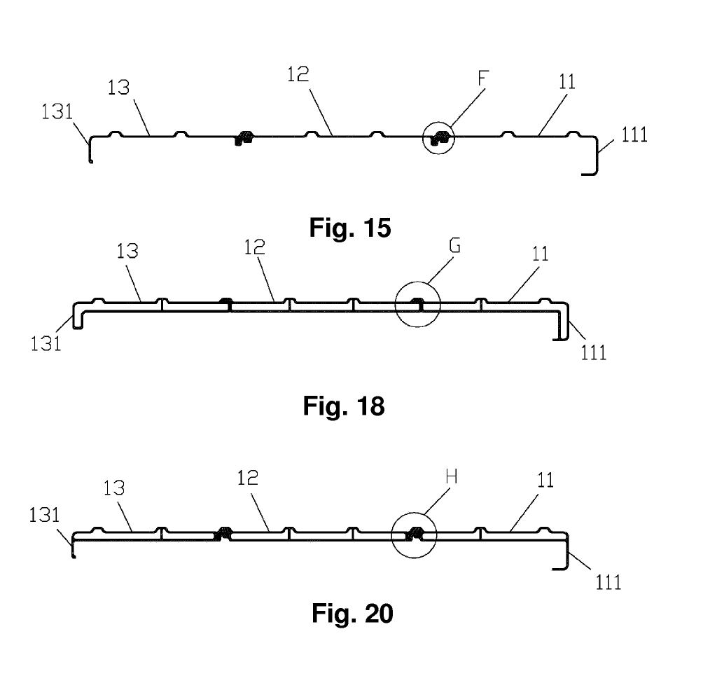

refer to the FIG. 15 and the FIG. 16, the top tread for simple aluminum ladder in the present invention has differences from the embodiment 1. In the embodiment 4, the link edge of the first single element of the two splice neighboring single elements (that is the middle single element 12) is equipped with U-shape end 71 opening upwards and crosswise hook extending out, and the link edge of the second single element of the two splice neighboring single elements (that is the front single element 11) is equipped with side U-shape end 72 opening inwards and upright hook 721 extending downward. The crosswise hook 711 of the first single element (that is the middle single element 12) works corporate with the side U-shape end 72 of the second single element (that is the front single element 11), and the upright hook 721 of the second single element (that is the front single element 11) work corporate with the U-shape end 71 of the first single element (that is the middle single element 12) holding the neighboring front single element 11 and the middle single element 12 together.

The splice of the middle single element 12 and the back single element 13 applies the same structure to splice together.

### Embodiment 5

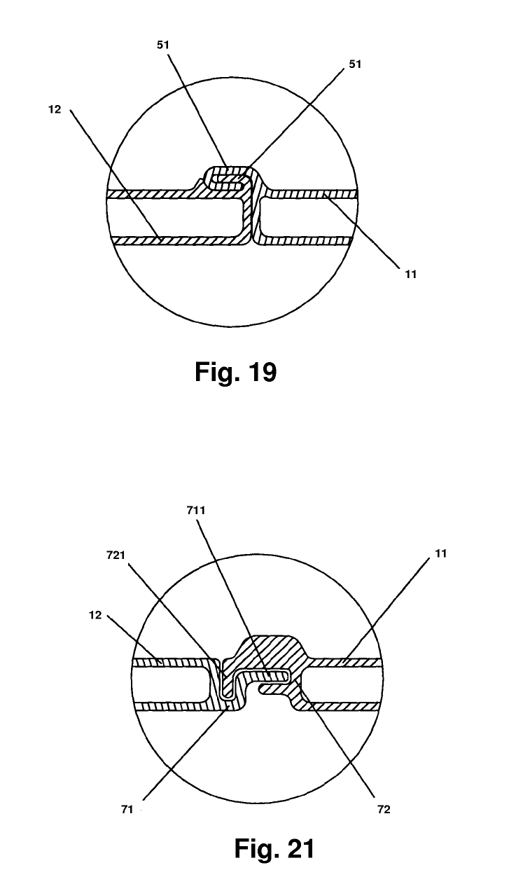

refer to the FIG. 17, FIG. 18 and the FIG. 19, the top tread for simple aluminum ladder in the present invention has differences from the embodiment 1. In the embodiment 5, the single element is a double-layer structure of single or multiple cavities. The intensity of the double-layer structure is stronger than that of single-layer, so that the top tread needs not metal tube. Two single tubes are selected to insert to the cavity of the two sides of the splice aluminum member 1 for enhancing the intensity of the top tread. The shape of the metal tube could be H-shape or u-shape or frame shape structure, placing the metal tube at the bottom of the splice aluminum member 1.

### Embodiment 6

refer to the FIG. 20 and the FIG. 21, the top tread for simple aluminum ladder in the present invention has differences from the embodiment 1. In the embodiment 6, the single element is a double-layer structure of single or multiple cavities. The intensity of the double-layer structure is stronger than that of single-layer, so that the top tread needs not metal tube. Two single tubes are selected to insert to the cavity of the two sides of the splice aluminum member 1 for enhancing the intensity of the top tread. The shape of the metal tube could be H-shape or u-shape or frame shape structure, placing the metal tube at the bottom of the splice aluminum member 1. the link edge of the first single element of the two splice neighboring single elements (that is the middle single element 12) is equipped with U-shape end 71 opening upwards and crosswise hook extending out, and the link edge of the second single element of the two splice neighboring single elements (that is the front single element 11) is equipped with side U-shape end 72 opening inwards and upright hook 721 extending downward. The crosswise hook 711 of the first single element (that is the middle single element 12) works corporate with the side U-shape end 72 of the second single element (that is the front single element 11), and the upright hook 721 of the second single element (that is the front single element 11) work corporate with the U-shape end 71 of the first single element (that is the middle single element 12) holding the neighboring front single element 11 and the middle single element 12 together.

The splice of the middle single element 12 and the back single element 13 applies the same structure to splice together.

Although the present invention has been fully described by ways of preferred embodiments with reference to the accompanying drawings, it is to be noted that various changes and modifications will be apparent to those skilled in the art. Therefore, unless otherwise such changes and modifications depart from the scopes of the present invention, they should be construed as being included therein.

### INDUSTRIAL APPLICABILITY

The present invention is provided with top tread for simple aluminum ladder, which is made from aluminum-plastic composite. The present invention of top tread for aluminum ladder has advantages of easily manufactory, graceful outline, stable supporting and low production cost, good industrial applicability as well.

1. Top tread for simple aluminum ladder, wherein, includes:
A splice aluminum member assembled by two or more aluminum single elements, the front and the rear end of the splice aluminum member are equipped with side skirts which are set downwardly;
Two side plastic members, the upper and the lower end of the side plastic members are equipped with an upper and a lower covering edge by which the two side plastic members can clamp the two sides of the splice aluminum member, and the upper and the lower covering edges can clamp the two side interspaces between the front and the back side skirt, which forms the integral top tread.

2. Top tread for simple aluminum ladder according to the claim 1, wherein further includes a metal tube to enhance the intensity of the top tread, at least two tubes of the metal tube are placed separately on the two sides of the splice aluminum member, two side plastic members can clamp the two sides of an assembly unit formed by the metal tube and the splice aluminum member, and the upper and the lower covering edges can clamp the two side interspaces between the front and the back side skirt.

3. Top tread for simple aluminum ladder according to the claim 1, wherein the aluminum single element is single-layer structure or a double-layer structure of single or multiple cavity.

4. Top tread for simple aluminum ladder according to the claim 3, wherein the link edge of two neighboring aluminum single elements is equipped with side U-shape end which is set opening inward, the side U-shape ends hook holding the two neighboring aluminum single elements together.

5. Top tread for simple aluminum ladder according to the claim 3, wherein the link edge of the first single element of the two neighboring aluminum single elements is equipped with upright hook, and the link edge of the second single element is equipped with U-shape end which is set opening upwards, the upright hook of the first single element inserts to the U-shape opening of the second single elements holding the first and the second single elements together.

6. Top tread for simple aluminum ladder according to the claim 3, wherein the link edge of the first single element of the two neighboring aluminum single elements is equipped with U-shape end opening upwards and crosswise hook extending outwards, and the link edge of the second single element is equipped with side U-shape end opening inward and upright hook extending downwards, the crosswise hook of the first single element works cooperate with the U-shape opening of the side U-shape end of the second single element, the upright hook of the second single element works cooperate with the U-shape opening of the U-shape end of the first single element holding the first and the second single element together.

7. Top tread for simple aluminum ladder according to the claim 3, wherein the upper end of the single element is equipped with several transverse raised lines by extrusion forming, the upper covering edge of the side plastic member is equipped with several breach for making room for the raised lines of the single element.

8. Top tread for simple aluminum ladder according to the claim 3, wherein the upper surface of the single element is equipped with several printing structures in particular rows by extrusion forming.

9. Top tread for simple aluminum ladder according to the claim 2, wherein the metal tube is two-single-tube, or H-shape structure or U-shape structure or frame structure by tubes.

10. Top tread for simple aluminum ladder according to the claim 9, wherein the metal tube is made of iron material or aluminum material.

11. Top tread for simple aluminum ladder according to the claim 2, wherein the aluminum single element is single-layer structure or a double-layer structure of single or multiple cavity.

12. Top tread for simple aluminum ladder according to the claim 11, wherein the link edge of two neighboring aluminum single elements is equipped with side U-shape end which is set opening inward, the side U-shape ends hook holding the two neighboring aluminum single elements together.

13. Top tread for simple aluminum ladder according to the claim 11, wherein the link edge of the first single element of the two neighboring aluminum single elements is equipped with upright hook, and the link edge of the second single element is equipped with U-shape end which is set opening upwards, the upright hook of the first single element inserts to the U-shape opening of the second single elements holding the first and the second single elements together.

14. Top tread for simple aluminum ladder according to the claim 11, wherein the link edge of the first single element of the two neighboring aluminum single elements is equipped with U-shape end opening upwards and crosswise hook extending outwards, and the link edge of the second single element is equipped with side U-shape end opening inward and upright hook extending downwards, the crosswise hook of the first single element works cooperate with the U-shape opening of the side U-shape end of the second single element, the upright hook of the second single element works cooperate with the U-shape opening of the U-shape end of the first single element holding the first and the second single element together.

15. Top tread for simple aluminum ladder according to the claim 11, wherein the upper end of the single element is equipped with several transverse raised lines by extrusion forming, the upper covering edge of the side plastic member is equipped with several breach for making room for the raised lines of the single element.

16. Top tread for simple aluminum ladder according to the claim 11, wherein the upper surface of the single element is equipped with several printing structures in particular rows by extrusion forming.
